(19) United States
(12) Patent Application Publication
(10) Pub. No.: US 2016/0234678 A1
(43) Pub. Date: Aug. 11, 2016

(54) CONFIGURATION OF WIRELESS DEVICES

(71) Applicant: TEXAS INSTRUMENTS INCORORATED, Dallas, TX (US)

(72) Inventor: AVI BAUM, GIVA'T SHMUEL (IL)

(21) Appl. No.: 14/827,857

(22) Filed: Aug. 17, 2015

Related U.S. Application Data
(60) Provisional application No. 62/114,490, filed on Feb. 10, 2015.

(51) Int. Cl. H04W 8/22; H04W 76/02

(52) U.S. Cl. CPC H04W 8/22; H04W 76/023; H04W 76/022

(57) ABSTRACT

As one example, a method includes sending a request in a secure wireless network from a first device. The request includes a predetermined information element indicating the first device is capable of implementing a peer configuration method. In response to receiving a reply that includes the predetermined information element from at least one other device, which is already operating in the wireless network, the method also includes establishing a secure channel between the first device and the other device. The method also includes receiving at the first device network configuration data via the secure channel, the network configuration data sufficient to enable the first device to connect to the wireless network.

### CROSS-REFERENCE TO RELATED APPLICATION

This application claims the benefit of U.S. Provisional Patent Application 62/114490 filed on Feb. 10, 2015, and entitled WIFI CLONE CONFIG, the entirety of which is incorporated herein by reference.

### TECHNICAL FIELD

This disclosure relates to configuring a wireless device to operate in a wireless network.

### BACKGROUND

The Internet of Things (IoT) is becoming more and more dominant and opens a new era for simple objects to connect to the Internet. One part of enabling a given device to connect to a local network is the step of on-boarding the given device to the local network. Various approaches have been developed to facilitate such initial connection to the local network. Users desire an easy-to-use solution that is full proof and as much as possible seamless. Yet, while making it seamless, security should not be compromised. The combination of these two goals can make this a challenging task.

### SUMMARY

This disclosure relates to configuring a wireless device to operate in a wireless network.

As one example, a method includes sending a request in a secure wireless network from a first device. The request includes a predetermined information element indicating the first device is capable of implementing a peer configuration method. In response to receiving a reply that includes the predetermined information element from at least one other device, which is already operating in the wireless network, the method also includes establishing a secure channel between the first device and the other device. The method also includes receiving at the first device network configuration data via the secure channel, the network configuration data sufficient to enable the first device to connect to the wireless network.

As another example, a wireless device can include a transceiver to wirelessly communicate data. The device can also include memory to store data and instructions and a processor to access the memory and execute the instructions for performing a method. The instructions can include a configuration manager that sends a request via the transceiver in a wireless network. The request includes a predetermined configuration information element to indicate that the wireless device is configured to implement a peer configuration method. The configuration manager can establish a secure wireless communications channel with another wireless device in response to receiving a reply from the other wireless device. The configuration manager can also employ network information received via the secure wireless communications channel to connect the wireless device in the wireless network.

As yet another example, another method includes receiving at a given device a wireless request that includes a predetermined configuration information element indicating a source device that provided the wireless request is configured to implement a peer configuration method. The method also includes providing a wireless response from the given device in response the wireless request. The wireless response includes the predetermined configuration information element to indicate that the given device is also configured to implement the peer configuration method. The method also includes establishing a secure wireless channel between the given device and the source device and sending network information from the given device to the source device via the secure channel to enable the source device to connect with the wireless network.

### BRIEF DESCRIPTION OF THE DRAWINGS

FIG. 1 depicts an example of a system demonstrating peer configuration of between wireless devices.

FIG. 2 depicts an example of a communication control system that can be implemented by a wireless device to implement peer configuration.

FIG. 3 depicts an example of configuration data that can be utilized by a configuration manager of a wireless device.

FIG. 4 depicts an example of a peer configuration information element that can be communicated from one wireless device to another.

FIG. 5 depicts an example of a configuration manager programmed to implement peer configuration.

FIG. 6 is a signaling diagram demonstrating flow of information between devices associated with a peer configuration method to facilitate connecting a new device with a wireless network.

FIG. 7 is a flow diagram depicting the method that can be utilized for configuring a wireless device to connect to a wireless network.

FIG. 8 is a flow diagram depicting an example of a method that can be implemented to configure another wireless device to connect with a wireless network.

### DETAILED DESCRIPTION

This disclosure relates to configuring a wireless device to operate in a wireless network. For example, a plurality of devices can be configured to implement a peer configuration method that enables a new device to obtain configuration information from another device that is already connected to operate in a wireless network. The already connected device can be referred to as a trusted agent. The new device announces its presence to one or more trusted agent, such as by transmitting a probe request that includes a predetermined information element identifying the new device as being configured to implement the peer configuration method. After mutual authentication for implementing the peer configuration method, the new device and the trusted agent can establish a secure wireless channel (e.g., via asymmetric cryptography). The trusted agent can then provide network access credentials to the new device via the secure wireless link to enable the new device to operate in the wireless network. In some examples, the process can be initiated and completed in the absence of user intervention. In other examples, user input can be required to complete the configuration process for the new device, such as by sending a message that requires confirmation by the user.

The systems and methods disclosed herein thus can provide a secure approach to facilitate connecting devices to a wireless local network. The approach further can be power efficient since the process is triggered by the new device avoiding the need to run power hungry background processes. If desired, devices can be programmed to provide closed loop feedback to confirm success or failure for connecting the new device in the wireless network.

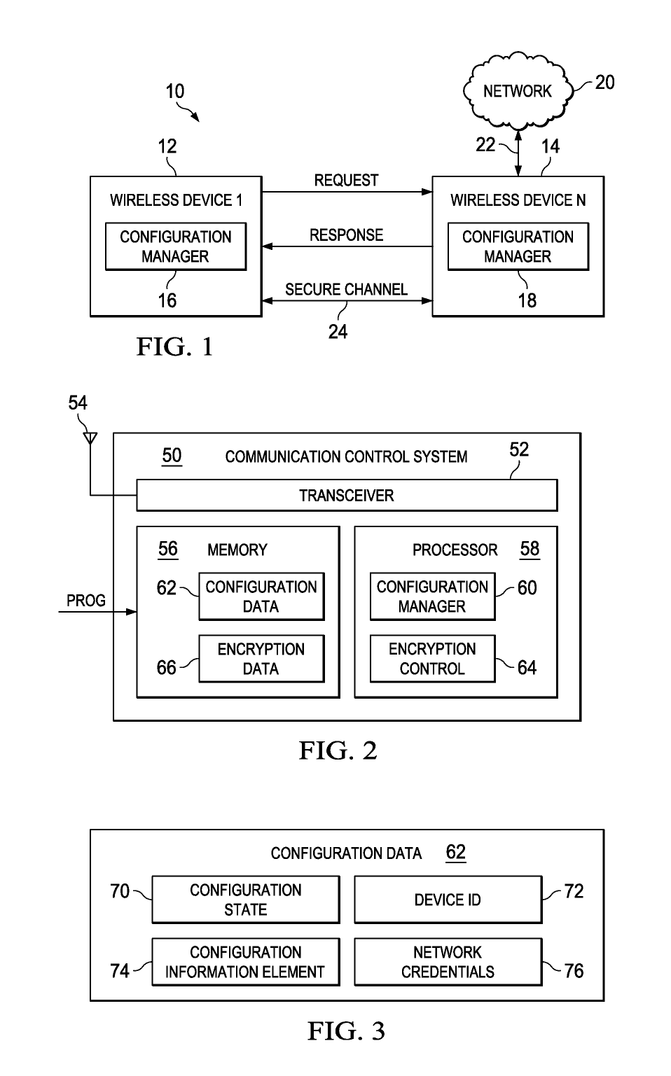

FIG. 1 depicts an example of a communication system 10 that includes two or more wireless devices 12 demonstrated as wireless devices 1 and wireless device N, where N is a positive integer denoting the number of wireless devices in the system 10. In the communication system 10, it is presumed that each of the wireless devices 12 and 14 is pre-configured to implement a peer configuration method. Each of the wireless devices includes a corresponding configuration manager 16 and 18, respectively, programmed to implement part of peer configuration method depending on its configuration state. For instance, configuration manager 16 and 18 functions differently depending on whether it is already configured and connected to the wireless network or if the device is pre-configured and thus not yet connected to the wireless network. The configuration manager 16 and/or 18 can be implemented as an integrated circuit (IC) such as on an IC chip.

In the example of FIG. 1, the wireless device 14 is already been connected with the wireless network 20, demonstrated via connection 22. The wireless network 20 can include one or more access points and implement the corresponding wireless protocol. Thus, the configuration manager 18 is configured with network information sufficient to connect with the wireless network. The network information includes a unique network identifier (e.g., a service set identifier (SSID)) that specifies a name for the wireless network 20. Additionally, for a secure wireless network, the network information programmed in the configuration manager 18 can include security credential for the wireless network 20. The security credentials can include a password that has been defined for the network according to an established security protocol. For the example of one of the 802.11X wireless technologies, the security credentials in the network information can correspond to a Wi-Fi protected access (WPA) or Wi-Fi protected access 2 (WPA2) password for such wireless network as well as any additional information required to gain network access (e.g. user ID for enterprise authentication, captive portal login credentials, roaming provider access codes etc.). It is to be understood that the communication system 10 and the wireless network 20 can be implemented according to other wireless communication protocols, such as low energy Bluetooth, IEEE 802.15.4 or ZigBee to name a few. The following examples will presume that the wireless networks are implemented according to one of the 802.11 family of standards (i.e., to a Wi-Fi network). However it is to be understood that the invention disclosed herein is equally applicable and can be implemented in the context other types of wireless communication protocols.

Referring back to FIG. 1, initially, it is presumed that the wireless device 12 is not configured to connect in the wireless network 20 and thus operates in a pre-configured state. The configuration manager 16 thus implements a search phase of the peer communication method in which the wireless device sends a scan request using a wireless communication protocol that is implemented by the network 20. For example, the scan can correspond to a probe request or other management frame that includes a predetermined configuration information element. The predetermined configuration information element identifies the wireless device 12 as being configured to implement the peer configuration method (i.e., it is a peer-configuration-capable device). Since, as mentioned above, the other wireless device 14 is also configured to implement the peer configuration method and already connected to the wireless network 20 via connection 22, the configuration manager 18 operates in a post-configured state. In the post-configured state, the configuration manager 18 of device 14 issues a corresponding response in response to the request received from the wireless device 12. Similar to the request, the response provided by the configuration manager 18 can include a predetermined configuration information element indicating that the wireless device 14 is also configured to implement the peer configuration method. This exchange between the wireless devices 12 and 14 can be utilized to establish a prescribed trusted relationship between the wireless devices.

Once the wireless devices 12 and 14 have established the prescribed relationship exists between the wireless devices (e.g., both being peer-configuration-capable devices), the devices 12 and 14 can create a peer-to-peer connection over a secure channel demonstrated at 24. The secure channel 24 can be implemented according to an asymmetrical cryptography scheme. In order to establish the secure communication channel 24, each of the wireless devices can exchange packets containing cryptographic keys according to a common cryptographic scheme. As one example, the cryptographic scheme can be implemented based on an elliptic curve Diffie-Hellman (ECDHE)-elliptic curve digital signature algorithm (ECDSA) key exchange according to a pre-programmed root certificate operating on the wireless device 12. The ECDHE-ECDSA cryptography provides an asymmetric cryptography protocol based on algorithms that require two separate keys, stored at and used by the devices 12 and 14. For example, the key exchange between the devices 12 and 14 can be implemented through another information element that is added to a management frame wireless communicated between the devices, such as in another probe request and/or associated probe response. The exchange can be utilized to create a multi-bit shared key for communicating authentic and secure data packets via the secure channel 24 between the devices 12 and 14. It is understood that each of the devices 12 and 14 could implement other cryptography schemes, such as including another public-key cryptography or symmetric-key cryptography.

The configuration manager 18 can in turn provide network information to the wireless device 12 via the secure channel sufficient to provision the wireless device 12 to connect with and operate in the wireless network 20. For example, the network information can include a network name (e.g., SSID), the network password and any additional metadata that can be utilized by the wireless device 12 to provide for secure communication by the device within the wireless network 20.

In some examples, such as to increase security, prior to the wireless device 14 providing the network information to the wireless device 12, the already-connected wireless device 14 can send a confirmation request to an authorized user of the network for approval to add the new device into the network 20. The confirmation request can be provided over the network 20. As an example, the confirmation request can be provided from the wireless device 14 directly or through a corresponding web service, such as email, instant messaging, text messaging or the like. In response to a user input from the authorized user confirming that the wireless device 12 is approved to connect with the wireless network 20, the wireless device 14 can then provide the network information via the secure channel to the wireless device 12.

Additionally or alternatively, as a further security measure, the wireless device 12 can provide a connection notification to one or more authorized user (e.g., the same or a different user to which the confirmation request was sent) that informs the user that the device 12 has successfully connected to the network 20. The connection notification from the new wireless device 12 can thus provide a positive acknowledgement to inform the authorized user of the successful completion of the overall configuration process. After the network information has been provided to the new wireless device 12, the wireless devices 12 and 14 can tear down the secure channel 24 thereby leaving each of the wireless devices connected with the wireless network 20. Additionally, if for some reason the new device 12 cannot connect to the network 20 (e.g., failure to establish a network connection), the configuration manager 18 of the new device can be programmed employ the secure communications channel 24 to notify the already-connected device 14 about the failure. Each device further may be manually configured in response to a user input, such as by connecting it to a computer or other terminal device. The notification via the secure link 24 can also include information identifying one or more reasons for the failure (e.g., one or more predefined reason codes).

FIG. 2 depicts an example of a communication control system 50 that can be implemented by a wireless device (e.g., one of the wireless devices 12 and 14 in the example of FIG. 1). For example, each of the wireless devices of FIG. 1 can include a communication control system 50 as well as other sensors, actuators or other components for programming to avoid various functions associated with the respective devices 12 through 14. The peer configuration method that is implemented by the configuration manager of each of the wireless devices can facilitate implementing each such device to operate as part of the internet of things (IoT). The communication control system 50 can be implemented as circuitry on an IC chip or its functionality could be distributed across circuitry contained on multiple IC chips.

As one example, each of the wireless devices 12 and 14 can be implemented as part of a distributed system (e.g., a home automation and/or burglar system), such as corresponding to sensors associated with different parts of a home or other facility. For instance, one of the wireless devices 12 can be a motion detector that can be provide an indication of sensed conditions via the network 20 to a system processor also part of the wireless network. Other devices can implement switches to detect the opening and closing of a circuit such as associated with the opening and closing of a door. Other examples of wireless devices can be configured for other automation functions, such as may include sensing and/or controls of various household devices. In still other examples, the wireless devices can be implemented as part of a vehicle, such as a car, boat, recreational vehicle or the like to implement various automation or sensing features as are known in the art. These functions are provided by of example and the potential applications are up to the user.

In the example, of FIG. 2, the communication control system 50 includes a transceiver 52 that is coupled to an antenna 54 to communicate wirelessly information over a bidirectional communication link. The transceiver 52 thus is configured to transmit information as well as receive information according to one or more wireless communications protocol, including the wireless protocol of a wireless network in which the system 50 is implemented. The communication control system 50 also includes memory 56 and a processor 58. The memory 56 includes data and instructions stored therein. The processor 58 can access the memory 56 to employ the data while executing the machine readable instructions stored in the memory. In the example of FIG. 2, as part of implementing the peer configuration method disclosed herein, the processor is programmed to execute instructions including a configuration manager (e.g., configuration manager 16 or 18 of FIG. 1) 60 and an encryption control 64.

The configuration manager 60, for example, can employ configuration data 62 for implementing the configuration method. The operation implemented by the configuration manager 60 can depend on configuration state of the system 50, which can be stored as part of the configuration data 62. An example of configuration data 62 is demonstrated in FIG. 3.

The configuration data 62 can include configuration state data 70 that specifies a state of the communication control system 50 that can be utilized to implement the third configuration method. For example, the configuration state 70 can include the following states pre-configured, connecting, connected, configuring and/or post-configured. Thus according to the respective state of a given device, a recipient of a given message containing such state information can respond accordingly, such as by providing a message or implementing a prescribed function, as disclosed herein. The configuration data 62 can also include a device identifier 72 that can uniquely identify a name for the wireless device operating in a corresponding wireless network.

The configuration data 62 can also include a configuration information element 74. The configuration information element 74 can include a predetermined identifier (e.g., a proprietary token) indicating that the wireless device supports the peer configuration technology. Additionally, in some examples, a wireless device operating in the post-configured state (as defined by its configuration data 62) can further be enabled or disabled as to whether the device is operative to provision one or more pre-configured wireless devices to operate in a network. For example, a manufacturer or a service provider can program one or more wireless devices to control which specific devices are programmed to implement certain post-configured controls for provisioning other wireless devices. If enabled, the configuration manager can cause the post-configured wireless device to send the configuration information element in a response message in response to receiving a request message from another wireless device that also includes the configuration information element.

The configuration data 62 can also include network credential 76 to specify network access credentials needed to connect in a wireless network. As mentioned, a network credentials can include an SSID, network password or other information that should be passed to the new device to enable operation within the wireless network. For example, additional information that may be included are the device name, owner information or other proprietary information that the manufacturer or user may wish to include to facilitate provisioning wireless devices in a seamless and secure manner.

Referring back to FIG. 2, the encryption control 64 that can employ encryption data 66 to set up, utilize and tear down the secure channel between wireless devices (e.g., secure channel 24 of FIG. 1) after exchanging messages that include the predetermined configuration information element. As an example, the encryption control method 64 can be implemented according to the ECDHE-ECDSA cryptography protocol; although other cryptography protocols could be utilized. For instance, the encryption data 66 can store a predetermined cryptographic key that can be provided to another wireless device for mutual authentication and for use in creating the secure communications channel. The cryptography protocol implemented by the encryption control 64 provides another level of security in addition to the configuration information element that is provided between devices as part of the initial exchange. Once authenticated, the encryption control 64 can employ a multi-bit shared key (also stored part of the encryption data 66) for communicating secure data packets, including network information, via the secure channel 24 as disclosed herein. That is, the encryption data 66 can provide keys for encrypting and decrypting information provided via the secure communications channel.

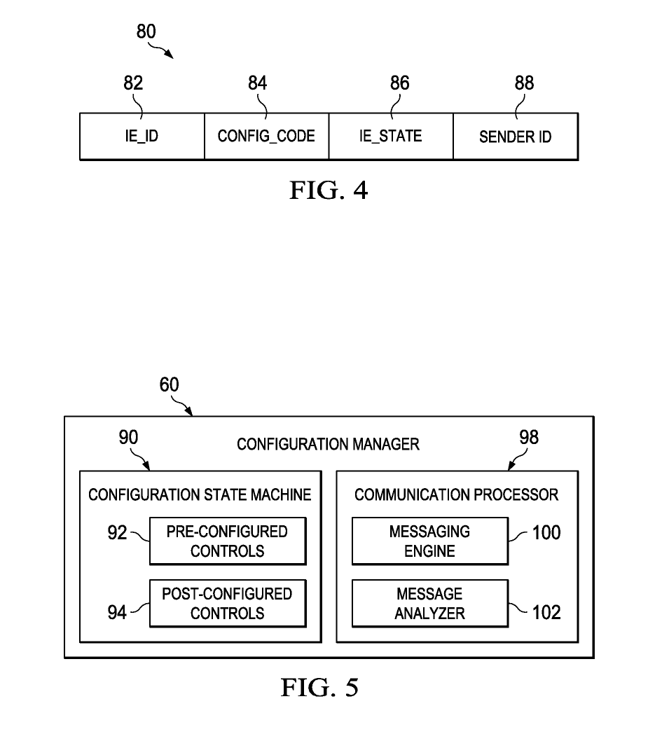

By way of further example, the communication control system 50 can send a management frame, such as a probe request, probe response or other type of management frame according to the wireless communication protocol being implemented. The management frame can include one or more information elements, such as including the information element 80. FIG. 4 depicts an example of a configuration information element 80 that can be provided (e.g., in a management frame) from a wireless device implementing a peer configuration method disclosed herein. The information element 80 can include an information element ID (IE_ID) that specifies a prescribed identifier to indicate that the particular type of content of the information element that is being provided in the management frame.

The information element 80 can also include a predetermined configuration code 84 that is stored as static or derived data (e.g., in configuration information element 74). For instance, the configuration code 84 may be a proprietary static code to inform mutually configured other devices that the sender of the message containing the information element 80 is configured to implement the peer configuration method. The information element 80 can also include an indication of the information element state (IE_STATE) shown at 88. The information element state data 88, for example, specifies the current state or status of the information element according to the configuration state (e.g., configuration state data 70 of FIG. 3) for the wireless device from which the information element is sent. The information element state data 88 thus can be processed and evaluated to determine how each recipient device responds to the management frame that contains the information element 80. Other information can be included in the information element 80, such as an identifier for the sender (SENDER_ID) 86. The sender ID 86 can correspond to the device ID data 72 of the configuration data 62.

FIG. 5 depicts an example of the configuration manager 60 that can be programmed to perform the peer configuration method disclosed herein. As mentioned, the peer configuration method being implemented at a given wireless device (e.g., device 12 or 14 of FIG. 1) can vary depending on the configuration state of the each device. Thus, the configuration manager 60 can include a configuration state machine 90. The configuration state machine 90 can implement a plurality of different states, which the state machine can traverse as part of the peer configuration method.

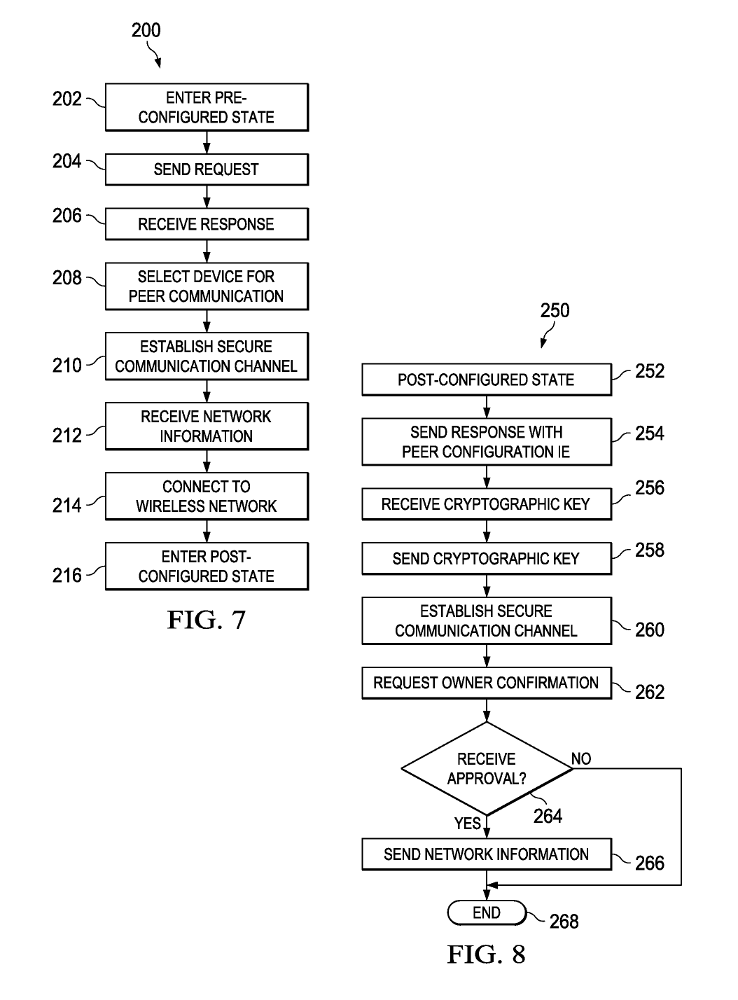

As one example, the configuration state machine 90 can implement logic to transition among the various states which generally will vary depending upon whether the device implementing the state machine is in the pre-configured state or post-configured state. Thus, in the example of FIG. 5, for simplicity of explanation, the configuration state machine 90 is demonstrated as including pre-configured controls 92 and post-configured controls 94. The pre-configured controls implement a sequence of logic that can be implemented by a pre-configured wireless device for configuring the device to operate in a wireless network. After the wireless device is configured to operate in the wireless network, the device will transition from the pre-configured state to a post-configured state and, in turn, implement the post-configured controls 94. The post-configured controls 94 can be user programmable such as by a manufacturer or user, such as mentioned above. An example of a peer configuration method that can be implemented by the pre-configured controls 92 is demonstrated in the flow diagram of FIG. 7. An example of a peer configuration method that can be implemented by the post-configured controls 94 is demonstrated in the example of FIG. 8.

The configuration manager 60 also includes a communication processor 98 that is configured to control communications from a wireless device. As disclosed herein, the communications related to the peer configuration method can include requests or responses. Thus the communication processor 98 can implement a messaging engine 100 to send a management frame, such as a probe request or probe response (e.g., communicated by the transmitter portion of transceiver 52). Additionally, as part of a request or response, the messaging engine 100 can include a corresponding information element in each management frame that is sent from a given wireless device to indicate the device implements the peer configuration method. The communication processor 98 can also include a message analyzer 102 to process messaged received (e.g., by receiver portion of transceiver 52) at the wireless device from other wireless devices. The communication processor 98 further can control the mode of communication and the channel over which the communication is sent depending on the configuration state data 70 (FIG. 3).

For example, the configuration state machine 90 for a pre-configured device is in the pre-configured state and thus the pre-configured controls 92 implement the corresponding peer configuration method. The pre-configured controls 92 can include instructions programmed to search for another wireless device that implements the peer configuration method, to connect to the other wireless device for establishing a secure communication channel and to configure the wireless device to connect with the wireless network based upon the network information provided from the other wireless device.

By way of further example, for a pre-configured wireless device the communication processor 98 can employ the messaging engine 100 to initiate the search by sending a probe request over a wireless communication channel according to wireless protocol. The message analyzer 102 can parse information received via the transceiver 52 to determine if a response from another wireless device contains a configuration information element indicating that the other wireless device implementing the peer configuration method. The communication processor 98 can in turn employ encryption control 64 to establish a clear communication channel between devices. Once the secure channel is established the device already configured can provide the network information to enable the pre-configured wireless device to operate in the wireless network.

In some examples, the wireless network can include a plurality of post-configured wireless devices and adapted to implement the peer configuration method. The pre-configured device can evaluate the responses if the responses are received and select one of the wireless devices based upon a ranking of the devices. For example, the pre-configured controls 92 can evaluate information provided in probe responses and select one of the responding peer device for establishing a secure connection based on one or more factors. Additionally, there can be multiple pre-configured devices (e.g., devices 12), which can be configured concurrently or sequentially for network operation. For instance, multiple preconfigured devices can be simultaneously configured by different pre-configured devices without interfering with one another (since communication obeys medium access rules).

As mentioned, the pre-configured controls or other methods implemented in the configuration manager 60 can rank the responding post-configured devices according to which of the plurality of devices has a greater reserve power available. Additionally or alternatively, signal strength can be utilized as a basis for selecting which peer wireless device to connect with over a secure communication channel. Additionally, if multiple access points are available, the pre-configured control 92 further can select a given peer wireless device based on the received signal strength between the access point and the pre-configured wireless device, such that the pre-configured wireless device will be connected with the access point with which it has the greatest signal strength. As further example, a manual selection (e.g., in response to a user input selection) based on device public name that is predefined, which can be utilized for configuring each of the pre-configured devices (e.g., one-by-one). Those skilled in the art will understand and appreciate that a combination of these and/or other criteria can be utilized by a pre-configured wireless device to select which of the plurality of post-configured wireless devices for connecting as part of the peer configuration method.

From the perspective of the configuration manager 60 that is implemented in the post-configured wireless device (described in the previous example as the already connected device), the post-configured device can also implement the post-configuration control 94 of the state machine and the communications processor 98 to communicate information to enable the pre-configured wireless device to operate in the wireless network. For example, the analyzer 102 parses the probe request from the pre-configured device and detects the configuration information element. In response to detecting the configuration information element, the configuration manager 60 employs the messaging engine 100 in the communication processor 98 of the post-configured device to issue a probe response that includes a corresponding information element, such as the information element 80 demonstrated in FIG. 4. The post-configured device will next receive a next message with the IE state indicating connected in the corresponding information element. The connected state can trigger the encryption control 64 and the communication processor 98 to cooperate and establish the secure communication channel, via which the post-configured device can provide the network information to the pre-configured device.

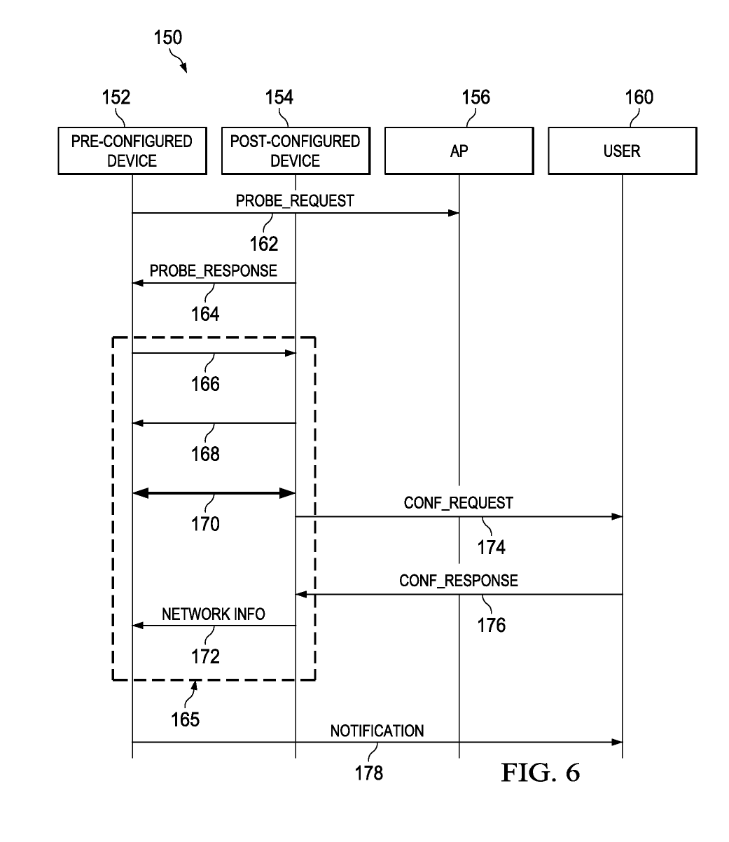

To help understand the flow of information between the pre-configured wireless device and a post-configured wireless device, FIG. 6 depicts an example of a signaling diagram 150. In the example of FIG. 6, the signaling diagram demonstrates a pre-configured device 152, a post-configured device 154, an access point 156, and a user 160. It is presumed that the pre-configured device is not connected with the wireless network implemented by the access point 156 and that the post-configured device 154 is already configured to operate in the wireless network. It is further presumed that each of these devices 152 and 154 have been configured to implement the peer configuration method disclosed herein, and thus includes a corresponding configuration manager 60 and related encryption control 64 to implement various parts of the peer configuration method, such as disclosed herein.

As an example, in response to activation and operating in a pre-configured state (e.g., configuration state 70 of FIG. 3), the pre-configured device 152 implements pre-configured controls 92 and issues a corresponding probe request, indicated at 162. Thus the probe request 162 can correspond to a scan in the network for searching for one or more wireless devices that implement the peer configuration method and are operating in the post-configured state. In this example, the post-configured device 154 (implementing post-configured controls 94 of FIG. 5) can send a probe response at 164 in response to the probe request issued by device 152, the post-configured device 154. In some examples, as part of the peer configuration method implemented by the post-configured control 94, the post-configured device 154 can periodically unsolicited probe responses at a low rate to facilitate configuring a new device that may have entered the network. In response to the probe response 164, one or both of the devices can in turn provide an additional probe message in which the status of the information element (IE state 88) can be changed to connecting to initiate a connection procedure between the devices 152 and 154, demonstrated at dashed line 165.

At 166, the pre-configured device 152 can provide a pre-programmed root certificate that is stored in memory of the device (e.g., part of the encryption data 66 of FIG. 2). The post-configured device can employ the key provided at 166 to derive a corresponding key that is to be utilized to authenticate the devices 152 and 154 to each other. Once a corresponding cryptographic key has been created for encrypting and decrypting data, a corresponding secure communication channel, indicated at 170, can be opened to enable peer-to-peer communication between the respective devices 152 and 154. The post-configured device 154 can provide corresponding network information to device 152 via the secure channel indicated at 172. The network information can include a network name (e.g., SSID) and a password required by the device 152 to connect with the wireless network.

In some examples, for additional security before sending the network information, the post-configured device 154 can send a request to the user 160 that may be connected to the network directly or via a corresponding service (e.g., email, text message, instant message or the like) that is accessible via the network 156. The user 160 thus can interact with a user interface to issue a confirmation response 176 in response to the confirmation request 174. In response to the post-configured device 154 receiving the confirmation response 176, the device 154 can issue the network information to the pre-configured device 152. In the absence of receiving an affirmative response confirming that the user has approved the new device to be connected in the wireless network, the post-configured device 154 can either not respond or send another message instructions to the pre-configured device 152, such as including instructions that it is not authorized to proceed.

As yet another example, in response to receiving the network information at 172, the pre-configured device 152 can provide a notification 178 to the user 160 via the network or associated services similar to the confirmation request 174. The notification provided at 178 can inform the user that the pre-configured device 152 has been successfully configured to operate in the wireless network and thus is connected to the access point 156 via an encrypted wireless protocol such as disclosed herein. If, for some reason, the connection to the wireless network fails, the pre-configured device can send a failure notification to the second device to via the secure wireless communications channel (e.g., identifying the failure as well as one or more reasons). Thus, the notification can provide feedback for closed loop operation.

FIG. 7 depicts an example of a method 200 that can be implemented by pre-configured controls (e.g., controls 92 of FIG. 5) of the configuration manager of a wireless device. The method begins at 202 in which the wireless device enters a pre-configured state. The device can enter the pre-configured state, for example, as an initial state of the device after powering up or otherwise being disconnecting from a wireless network. In the pre-configured state, at 204, the wireless device can send a request as part of a search for other wireless devices implementing the peer configuration method. The request, for example, can be a probe request or another form of management frame. The request can include an information element to identify the state of the device as well as its capability to implement the peer configuration method, such as the information element 80 disclosed with respect to FIG. 4.

One or more other wireless devices can send a response to the request, which response is received at 206. The response received at 206, for example, can be a probe response issued in response to the request or perhaps unsolicited by the other wireless device. At 208, if more than one response is received at 206, the method can include evaluating the responses and selecting one of a plurality of different post-configured device for peer communications. As disclosed herein, the selection can be based on signal strength of the wireless devices and its access point and/or one or more other factors such as power reserves of each of the respective devices. This can help avoid burdening devices with low power reserves as well as help ensure the device implementing the method will connect to the access point having the highest signal strength.

At 210, a secure communication channel can be established between the pre-configured wireless device implemented at the method 200 and the device that was selected at 208. For instance, the secure communication channel 210 can be established using an asymmetrical cryptographic scheme such as disclosed herein. At 212, network information can be received via the secure communication channel. The network information can be stored in memory of the device (e.g., memory 56). At 214, the wireless device can employ the network information to connect with the wireless network and thereby be operational. At 214, the wireless device can enter its post-configured state.

FIG. 8 depicts an example of a method 250 that can be implemented by post-configured controls (e.g., controls 94 of FIG. 5) of a device that is already connected and operating in the wireless network. Thus, the method 250 begins at 252 in which the device is operating in the post-configured state. At 254, the device can send a response that includes the predetermined information element to indicate that the sender of the response is configured to implement the peer configuration method. For example, the response at 254 can be a probe response that includes the information element 80 disclosed with respect to FIG. 4 as well as identifying the state as a configured state. The response at 254 can be provided in response to a request that is received or it can be unsolicited, such periodically provided at a low rate.

Following sending the response at 254, the device can receive a cryptographic key from another wireless device at 256. In response to the key received at 256, at 258, a message can be sent back to the sender including a corresponding cryptographic key. The exchange of keys at 256 and 258 thus can be utilized to authenticate the wireless devices sending the respective keys. Upon authentication, at 260, a secure communication channel can be established between the wireless devices. In some examples, the method 250 can include requesting confirmation from the owner at 262. The confirmation request can required that the owner or other authorized user approve providing network information to add the new device in the wireless network.

At 264, a determination can be made whether approval has been received from the owner. If the owner provides approval in response to the request at 262, the method 200 can proceed to 266 in which the network information can be sent to the other device via the secured channel that was established at 260. If approval is not received or is not received within a predetermined time period, the method can proceed from 264 and end at 268. In some cases, a notification can be provided to the new device to indicate that approval is not received and that network information is not being provided. In such a situation, the new device can restart the peer configuration method in the pre-configured state. In other examples, the method 200 can be implemented as to not require owner confirmation, such that the method can proceed from 260 to 266 directly.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method comprising:
sending a request in a secure wireless network from a first device, the request including a predetermined information element indicating the first device is capable of implementing a peer configuration method;
in response to receiving a reply that includes the predetermined information element from at least one other device, which is already operating in the wireless network, establishing a secure channel between the first device and the other device; and
receiving at the first device network configuration data via the secure channel, the network configuration data sufficient to enable the first device to connect to the wireless network.

2. The method of claim 1, wherein establishing the secure channel comprises an asymmetric encryption scheme.

3. The method of claim 1, wherein the predetermined information element comprises a device identifier for the sender and a static code indicating that the first device is capable of implementing the peer configuration method.

4. The method of claim 1, wherein the at least one other device already operating in the wireless network comprises a plurality of other devices already operating in the wireless network, the secure channel being established between the first device a selected device of the plurality of other devices.

5. The method of claim 4, further comprising choosing the selected device from the plurality of other devices based on an evaluation of at least one of a relative signal strength, power reserve among the plurality of other devices that is determined from responses received at the first device from each of the plurality of other devices, and manual selection in response to a user input.

6. The method of claim 1, wherein the network configuration data is received in response to a user input entered at an authenticated device operating in the wireless network.

7. The method of claim 6, further comprising:
sending a confirmation request from the other device to an authorized user of the wireless network;
in response to a user confirmation being entered, sending the network configuration data from the other device to the first device.

8. The method of claim 7, further comprising one of (i) sending a notification from the first device to the authorized user to indicate that the first device has successfully connected to the wireless network or (ii) sending a failure notification from the first device to the second device to via the secure channel if the first device fails to connect to the wireless network.

9. The method of claim 1, wherein the first device is a headless device.

10. The method of claim 1, further comprising configuring the first device to operate in the wireless network using the network configuration data, corresponding to a post-configured state,
wherein the first device is programmed to operate as peer configuration enabled in the post-configured state for programming other pre-configured network devices to operate in the wireless network or being not enabled to program other pre-configured network devices.

11. A wireless device comprising:
a transceiver to wirelessly communicate data;
memory to store data and instructions;
a processor to access the memory and execute the instructions for performing a method comprising:
a configuration manager that sends a request via the transceiver in a wireless network, the request including a predetermined configuration information element to indicate that the wireless device is configured to implement a peer configuration method, the configuration manager establishing a secure wireless communications channel with another wireless device in response to receiving a reply from the other wireless device, the configuration manager employing network information received via the secure wireless communications channel to connect the wireless device in the wireless network.

12. The wireless device of claim 11, wherein the configuration manager comprises:
a messaging engine to generate the request based on predetermined configuration data stored in the memory; and
a state machine comprising pre-configured controls, which are enabled in a pre-configured state, to control the messaging engine to generate the request.

13. The wireless device of claim 11, wherein the state machine transitions to a post-configured state in response to successfully connecting the wireless device in the wireless network, the configuration manager further comprising:
a message analyzer to evaluate content of another request received from a pre-configured wireless device;
a messaging engine to generate a response to the other request from the pre-configured wireless device and to provide the network information to enable the pre-configured wireless device to connect in the wireless network; and
post-configured controls, which are operative in the post-configured state, to control the messaging engine to generate the response based on the evaluating by the message analyzer.

14. The wireless device of claim 13, wherein the post-configured controls are programmed to control the transceiver to send a confirmation request to a user prior to sending the response to the pre-configured wireless device, the messaging engine sending the response via the transceiver to the pre-configured wireless device in response to receiving approval from the user.

15. The wireless device of claim 11, wherein the configuration manager is programmed to select the other wireless device from a plurality of available other wireless devices based on evaluating criteria in responses received from each of the plurality of available other wireless devices.

16. The wireless device of claim 11, wherein the configuration manager is programmed to one of:
send a notification to a user in response to successfully connecting with the wireless network; or
send a failure notification from to the second device to via the secure wireless communications channel if the pre-configured wireless device fails to connect to the wireless network.

17. The wireless device of claim 11, wherein the network information comprises at least a network identifier and a password required to connect with the wireless network.

18. The wireless device of claim 11, wherein the memory further comprises encryption data specifying a cryptographic key, the transceiver providing the cryptographic key to the other device to establish the secure wireless communications channel.

19. A method comprising:
receiving at a given device a wireless request that includes a predetermined configuration information element indicating a source device that provided the wireless request is configured to implement a peer configuration method;
providing a wireless response from the given device in response the wireless request, the wireless response including the predetermined configuration information element to indicate that the given device is also configured to implement the peer configuration method;
establishing a secure wireless channel between the given device and the source device; and
sending network information from the given device to the source device via the secure channel to enable the source device to connect with the wireless network.

20. The method of claim 19, wherein prior to sending the network information, the method comprises:
requesting a user confirmation response to approve the sending of the sending network information to the source device; and
in response to receiving the user confirmation response, sending network information to the source device.
